(19) United States
(12) Patent Application Publication
(10) Pub. No.: US 2016/0339591 A1
(43) Pub. Date: Nov. 24, 2016

(54) KNIFE WITH CUSTOMIZABLE ACCESSORIES

(71) Applicant: Shao Ching Sung, Chino, CA (US)

(72) Inventor: Shao Ching Sung, Chino, CA (US)

(21) Appl. No.: 14/715,328

(22) Filed: May 18, 2015

(51) Int. Cl. B26B 1/02; B25G 1/00

(52) U.S. Cl. CPC B26B 1/02; B25G 1/00

(57) ABSTRACT

A knife with customizable accessories has a pair of blade retainers, namely a first blade retainer and a second blade retainer mounted parallel to each other. The first blade retainer and the second blade retainer are planar in shape. A blade swivel retainer opening is formed for receiving a swivel bolt that connects between the pair of blade retainers. A knife blade is mounted to the pair of blade retainers at a blade swivel that allows the knife blade to swivel relative to the pair of blade retainers. An accessory rail is mounted over the first blade retainer having a pair of rail tips, namely a first rail tip and a second rail tip. An accessory has an accessory slot formed on the accessory. The accessory is mounted by the accessory slot to the accessory rail.

### FIELD OF THE INVENTION

The present invention is in the field of knives having customizable accessories.

### DISCUSSION OF RELATED ART

A variety of different knives have accessories such as lights and other tools connected for multifunctional use. Knives have also been decorated by ceremonial ornamentation such as fine jewels, diamonds and other kinds of gaudy design paraphernalia. Although knives have been configured to mount on rails, with the knife being the accessory, knives have not received accessories mounted on a blade handle.

### SUMMARY OF THE INVENTION

An object of this invention is to provide customizable functionality as well as customizable ornamentation by providing tooling modules as well as ornamental modules together in a customizable knife. A knife with customizable accessories has a pair of blade retainers, namely a first blade retainer and a second blade retainer mounted parallel to each other. The first blade retainer and the second blade retainer are planar in shape. A blade swivel retainer opening is formed for receiving a swivel bolt that connects between the pair of blade retainers. A knife blade is mounted to the pair of blade retainers at a blade swivel that allows the knife blade to swivel relative to the pair of blade retainers. An accessory rail is mounted over the first blade retainer having a pair of rail tips, namely a first rail tip and a second rail tip. An accessory has an accessory slot formed on the accessory. The accessory is mounted by the accessory slot to the accessory rail.

The knife has a front panel, a rear panel opposing the front panel, an upper panel, and a lower panel opposing the upper panel. The front panel, rear panel, upper panel, and lower panel are connected to each other to form the accessory slot. The accessory slot is configured to mount to the accessory rail. The accessory can be an accessory letter. The accessory can have an illumination element mounted on it. The illumination element can be an LED. The illumination element can also be a plastic faux gem that has an LED in it. The rail frame is mounted over the first blade retainer, and the accessory rail is mounted to the rail frame. The rail frame further includes a pair of tines extending from the rail frame. The pair of tines are attached to an end cap. The accessory rail is connected to the end cap. The rail frame and the end cap are both mounted over the first blade retainer. The rail frame is mounted over the first blade retainer, and the accessory rail is mounted to the rail frame. The rail tip frame opening secures the rail frame to the second rail tip at the second rail tip opening.

A variety of different accessories can be mounted to the rail. The accessories generally have a rectangular flat opening that retains a main body of the accessory to the rail. The accessories can be loose allowing sliding back and forth on the rail with gravity or can be more tightly mounted to the rail such that the accessories do not slide back and forth on the rail. Loose and tight mounting can be mixed so that some accessories slide while others do not.

### BRIEF DESCRIPTION OF THE DRAWINGS

FIG. 1 is a perspective view of the closed knife without the rail frame 31.

FIG. 2 is a perspective view of the rail frame.

FIG. 3 is a perspective view of the accessory rail.

FIG. 4 is a perspective view of body bolts 46 with FIGS. 1-4 collectively being an exploded perspective view of the present invention.

FIG. 5 is a side view of an accessory letter that is encrusted with bling faux plastic gem ornamentation.

FIG. 6 is a second side view of an accessory letter that is encrusted with bling faux plastic gem ornamentation.

FIG. 7 is a side view of the knife in partially opened configuration. The following callout list of elements can be a useful guide in referencing the elements of the drawings.

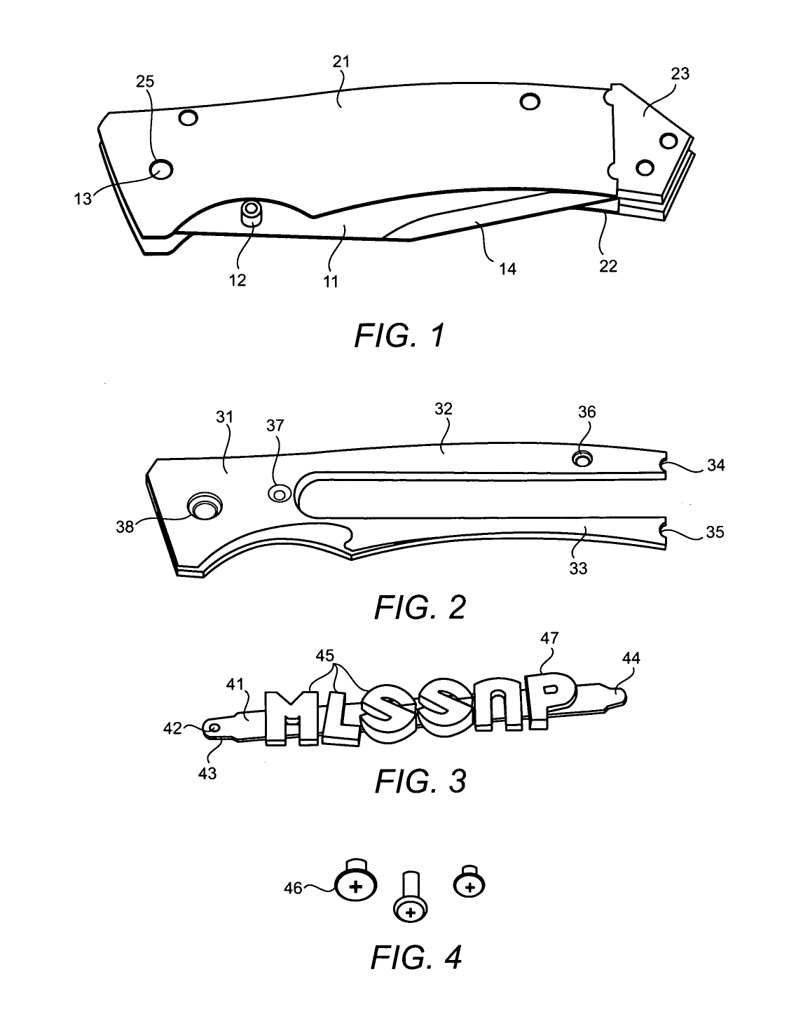

11 Blade
12 Grip Post
13 Blade Swivel
14 Blade Bevel
15 Blade Point
16 Secondary Cutting-Edge
17 Main Cutting Edge
18 Blade Spine
21 First Blade Retainer
22 Second Blade Retainer
23 Blade Retainer End Cap
24 Retainer Notch
25 Blade Swivel Retainer Opening
26 First End Cap Connection
27 Second End Cap Connection
28 First End Cap Opening
29 Second End Cap Opening
123 End Cap Protrusion
31 Rail Frame
32 First Tine
33 Second Tine
34 Rail Frame First Indent
35 Rail Frame Second Indent
36 First Tine Frame Opening
37 Rail Tip Frame Opening
38 Blade Swivel Frame Opening
41 Accessory Rail
42 Second Rail Tip Opening
43 Second Rail Tip
44 First Rail Tip
45 Accessory
46 Body Bolts
47 Accessory Letter
51 Accessory Slot
52 Illumination Element
53 Front Panel
54 Rear Panel
55 Upper Panel
56 Lower Panel
57 LED Illumination Element
58 Bling Illumination Element

### DETAILED DESCRIPTION OF THE PREFERRED EMBODIMENT

The present invention can be formed as a folding knife or a fixed knife. In the case of a folding knife, the folding knife can have a blade 11 with a grip post 12 also called a flipper that allows a user to flip open the knife. The blade 11 can be mounted on a blade swivel 13 which may have bearings or an oiled axle. The blade bevel 14 can be behind the blade point 15. The blade bevel 14 can be sharp like a swage or can be blunt. Additionally, the blade can have a main cutting edge 17 with a secondary cutting-edge 16 adjacent to the main cutting edge 17. The blade spine 18 can be along the back of the blade and the grip post 12 can be mounted to the blade spine 18. Opposite the blade point 15 is a blade swivel 13.

The folding knife can be received between a pair of blade retainers, namely a first blade retainer 21 and a second blade retainer 22. The first blade retainer 21 and the second blade retainer 22 are probably made of metal sheets punched to a profile of a knife handle. The blade retainers become the knife handle into which the knife blade can retract. The first blade retainer 21 and the second blade retainer 22 can receive a portion of a handle mounted to an external surface of the pair of blade retainers. The pair of blade retainers are set off from each other by posts or pins. The first blade retainer 21 and the second blade retainer 22 are planar and parallel to the blade 11. The pair of blade retainers are connected by bolts. A blade retainer end cap 23 can connect to the pair of blade retainers for securing the blade point 15. A retainer notch 24 can provide a convenient finger access for handling the grip post 12 when the knife is in closed position. The grip post 12 is secured to the blade 11 at the blade spine 18.

The first end cap connection 26 and second end cap connection 27 form a connection between the pair of blade retainers and the blade retainer end cap 23. An end cap protrusion 123 can be used for providing a first end cap connection 26 and a second end cap connection 27. The end cap protrusion 123 can fit into the rail frame first indent 34 and the rail frame second indent 35.

The rail frame first indent 34 and the rail frame second indent 35 can be formed as semicircular cutouts in the first tine 32 and the second tine 33. The first tine frame opening 36 can secure the first tine to the first blade retainer 21. The first tine 32 and the second tine 33 are connected together at a main portion of the rail frame and also at the blade retainer end cap 23.

A blade swivel retainer opening 25 can be formed through the pair of blade retainers for receiving a swivel bolt that connects between the pair of blade retainers to secure the blade 11 to the pair of blade retainers. A first end cap opening 28 and a second end cap opening 29 provide mounting locations for connectors such as bolts and pins to connect a portion of the end cap to the first blade retainer 21. The blade swivel retainer opening 25 can be spring-loaded or bearing enabled to provide smoother or faster opening.

The blade retainer end cap 23 is located parallel to the rail frame 31. The blade retainer end cap 23 and the rail frame 31 form an outside layer that is secured in a laminate fashion to the first blade retainer 21. The outside layer covers the first blade retainer 21 and is secured to the first blade retainer 21 using bolts or other types of commonly available connectors.

The rail frame 31 has a rail tip frame opening 37 that secures the rail frame 31 to the second rail tip 43 at the second rail tip opening 42. The second rail tip opening 42 coincides with the rail tip frame opening 37 in overlay alignment to allow a screw or bolt to pass through the rail tip frame opening 37 and secured to the second rail tip opening 42. The rail frame 31 is also secured to the blade first retainer 21 at the blade swivel frame opening 38. The blade swivel frame opening 38 allows a body bolt 46 to pass through it and engage with the blade swivel retainer opening 25. The blade swivel 13 is provided at the blade swivel retainer opening 25 because the body bolt 46 has a smooth outside surface for engaging a smooth inside surface of the swivel opening of the blade 11.

The second rail tip opening 42 secures the accessory rail 41 to the rail frame 31. A variety of different accessories 45 and accessory letters 47 can be mounted to the accessory rail 41. The first rail tip 44 connects to the blade retainer end cap 23 at an indent formed on the blade retainer end cap 23.

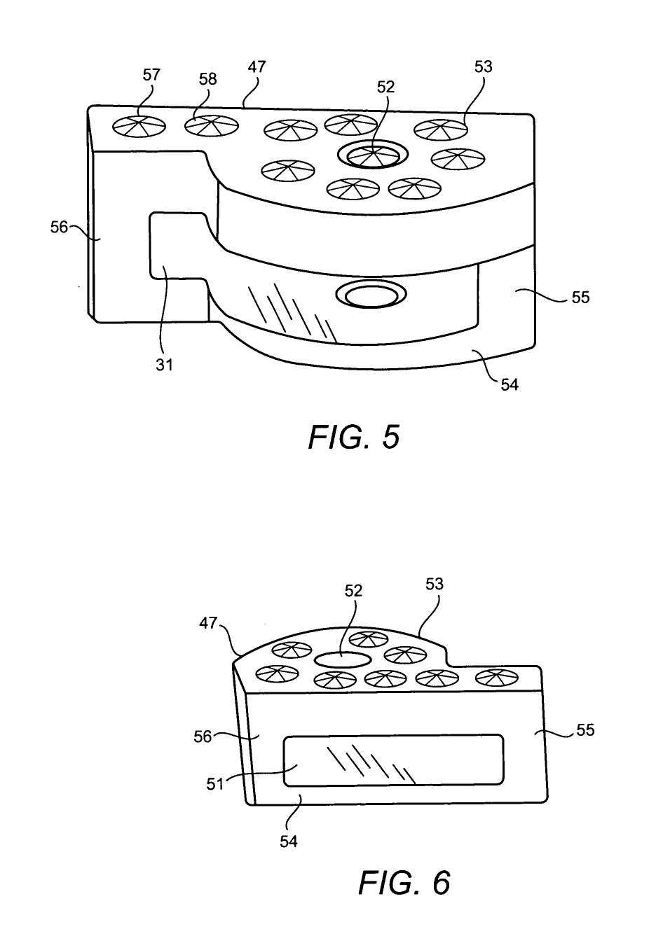

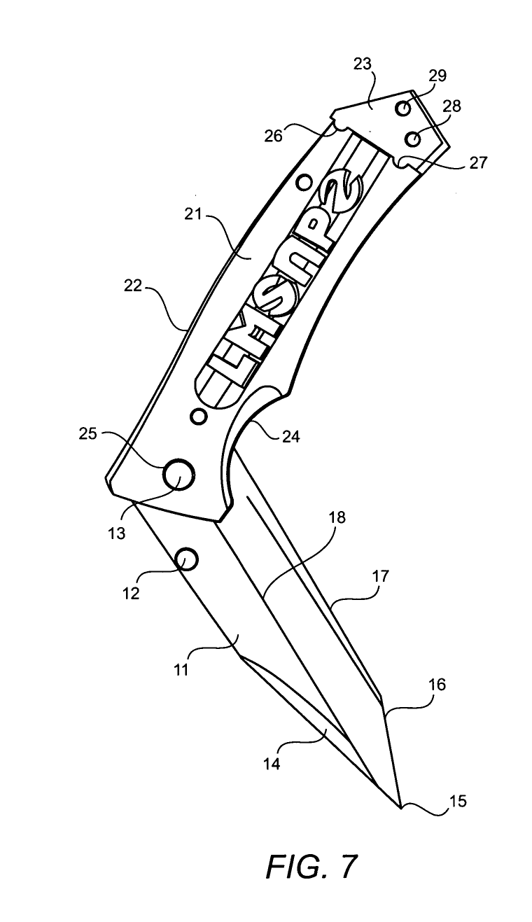

An accessory 45 such as an accessory letter 47 preferably has an accessory slot 51 that receives the accessory rail 41 so that the accessory rail 41 slides inside the accessory slot 51. The opening accessory slot 51 can be completely closed, or may have an opening so that it is only partially closed. The accessory slot 51 is bounded by the front panel 53, the rear panel 54, the upper panel 55, and the lower panel 56. As shown in FIG. 5, the letter ‘P’ can have an illumination element 52 used as decoration. The illumination element 52 can be an active light such as an LED lamp or can be a passive light such as a plastic prismatic faux gem ornament. The LED illumination element 57 can blink or cycle color. The bling illumination element 58 can have prismatic effect or can be translucent opal for example. The upper panel 55 is preferably perpendicular to the front panel 53. The front panel 53 is preferably perpendicular to the lower panel 56. The lower panel 56 is preferably perpendicular to the rear panel 54. The rear panel 54 is preferably perpendicular to the upper panel 55. The accessory slot 51 is preferably parallel to the upper panel 55, the front panel 53, the lower panel 56, and the rear panel 54.

The illumination element 52 can be an LED light, or laser. The accessories 45 can be a variety of different functional and decorative elements. For example, the accessories 45 can have a bubble level mounted within a portion of the letter, a nail file surface on an exterior portion of a letter, or a mirror on a smooth portion of a letter. Decorative elements such as faux stones and other bling ornamentation can also be mounted to the accessory 45. The illumination element 52 can further include photovoltaic generation means to provide electricity for a light-emitting diode (LED).

A user can use a screwdriver to remove the accessories 45 from the accessory rail 41 by releasing the first rail tip 44 from the blade retainer end cap 23, and by releasing the second rail tip 43 from the rail frame 31. The user can change the order of the letters to make different words from the letters provided. The user can also add or delete letters or words to provide a different message. The user can also add different functionality by interchanging a bling ornamented letter with an LED letter for example. The personalization of the interchangeable ornamentation provides an opportunity for the user to spell their own name or provide some other message. The bling accessories can further include princess cut faux diamonds mounted on an external channel formed in an outside surface of the accessory 45. Any of the bling accessories could also have a leaf spring clicker mounted within so that the letters make a clicking sound when pressed.

The metal rail preferably has a rectangular cross-section with the accessory opening for receiving the metal rail also having a rectangular cross-section that is larger than the rectangular cross-section of the metal rail. A letter accessory is preferably approximately about 1 cm in height or between 0.5 cm and 3 cm in height. The rectangular cross-section of the metal rail preferably has a height of more than 50% of the height of a letter. The height of the letter is defined as a height when viewed from the orientation of a viewer or user reading the letter. Two, three or six or more letters can be independently mounted to the metal rail with some loosely sliding and some tight enough not to slide without manual adjustment. The letter accessories are preferably metal to match the metal outer handle housing of the folding knife. The letter accessories can also be mounted to a non-folding knife.

1. A knife with customizable accessories comprising:
a. a pair of blade retainers, namely a first blade retainer and a second blade retainer mounted parallel to each other, wherein the first blade retainer and the second blade retainer are planar in shape;
b. a blade swivel retainer opening formed for receiving a swivel bolt that connects between the pair of blade retainers;
c. a knife blade, wherein the knife blade is mounted to the pair of blade retainers at a blade swivel that allows the knife blade to swivel relative to the pair of blade retainers;
d. an accessory rail mounted over the first blade retainer having a pair of rail tips, namely a first rail tip and a second rail tip; and
e. an accessory having an accessory slot formed on the accessory, wherein the accessory is mounted by the accessory slot to the accessory rail.

2. The knife of claim 1, wherein the accessory further includes:
a. a front panel;
b. a rear panel opposing the front panel;
c. an upper panel; and
d. a lower panel opposing the upper panel, wherein the front panel, rear panel, upper panel, and lower panel are connected to each other to form the accessory slot, wherein the accessory slot is configured to mount to the accessory rail.

3. The knife of claim 1, wherein the accessory is an accessory letter.

4. The knife of claim 1, wherein the accessory has an illumination element mounted on it.

5. The knife of claim 1, wherein the illumination element is an LED.

6. The knife of claim 1, wherein the illumination element is a plastic faux gem.

7. The knife of claim 1, further including a rail frame mounted over the first blade retainer, wherein the accessory rail is mounted to the rail frame.

8. The knife of claim 7, wherein the rail frame further includes a pair of tines extending from the rail frame.

9. The knife of claim 8, wherein the pair of tines are attached to an end cap.

10. The knife of claim 9, wherein the accessory rail is connected to the end cap.

11. The knife of claim 10, wherein the rail frame and the end cap are both mounted over the first blade retainer.

12. The knife of claim 11, further including a rail frame mounted over the first blade retainer, wherein the accessory rail is mounted to the rail frame.

13. The knife of claim 12, further including a rail tip frame opening that secures the rail frame to the second rail tip at the second rail tip opening.

14. The knife of claim 13, wherein the accessory further includes:
a. a front panel;
b. a rear panel opposing the front panel;
c. an upper panel; and
d. a lower panel opposing the upper panel, wherein the front panel, rear panel, upper panel, and lower panel are connected to each other to form the accessory slot, wherein the accessory slot is configured to mount to the accessory rail.

15. The knife of claim 14, wherein the accessory is an accessory letter.

16. The knife of claim 14, wherein the accessory had an illumination element mounted on it.

17. The knife of claim 14, further including a rail frame mounted over the first blade retainer, wherein the accessory rail is mounted to the rail frame.
